(19) United States
(12) Patent Application Publication
(10) Pub. No.: US 2004/0027783 A1
(43) Pub. Date: Feb. 12, 2004

(54) Structure of metal-metal capacitor

(75) Inventors: Cheng-Lyeh Wang, Taoyuan (TW); Tony Lin, Taoyuan (TW); Daniel Chen, Chang-Hu Hsien (TW)

Correspondence Address: MERCHANT & GOULD PC, P.O. BOX 2903, MINNEAPOLIS, MN, 55402-0903, US

(73) Assignee: UNITED MICROELECTRONICS CORP., Hsin-Chu (TW)

(21) Appl. No.: 10/349,682

(22) Filed: Jan. 22, 2003

Related U.S. Application Data
(62) Division of application No. 10/215,738, filed on Aug. 8, 2002, now abandoned.

(51) Int. Cl. H01G 4/228

(52) U.S. Cl. 361/306.3

(57) ABSTRACT

A structure of metal-metal capacitor and the method for fabricating the metal-metal capacitor (MMC) is presented. Wherein the lower electrode of the metal-metal capacitor is located in the uppermost layer of said semiconductor structure. A bonding pad employed as the connection of the semiconductor structure and the outside can be fabricated with the upper electrode of said metal-metal capacitor. The above-mentioned process can fabricate a metal-metal capacitor over the uppermost layer of a semiconductor structure efficiently. Moreover, in said method, this invention can not only save a mask in the manufacture, but also raise the capacitance of the metal-metal capacitor by extending the electrode of the metal-metal capacitor.

### BACKGROUND OF THE INVENTION

1. Field of the Invention

The present invention relates to metal-metal capacitors. More particularly, the present invention relates to metal-metal capacitors formed over a semiconductor structure.

2. Description of the Prior Art

So called “metal-metal capacitors”, i.e. capacitors whose two electrodes are made of metal. In the prior art, the metal-metal capacitors, as well as interconnection metals, are formed within a semiconductor structure so as to match the interconnection metals, as shown in FIG. 1.

FIG. 1 is a diagram of part of integrated circuit produced in prior art. Referred to FIG. 1, a metal-metal capacitor 140 is formed within a semiconductor structure comprising many interconnection members 100, wherein the metal-metal capacitor 140 is made of a lower electrode 110, a dielectric layer 120, and an upper electrode 130. Because the metal-metal capacitor 140 is formed within the semiconductor structure, the extension of both of the electrodes of said capacitor is limited. And thus the capacitance will be limited. Additionally, there are at least three masks required in the process of fabricating a metal-metal capacitor within a semiconductor structure, and the complexity of the process will grow.

Consequently, for raising the efficiency in the manufacturing and the capacitance of metal-metal capacitors, this invention provides a more efficient method and structure of metal-metal capacitors.

### SUMMARY OF THE INVENTION

In accordance with the present invention, a method is provided for fabricating metal-metal capacitors over the uppermost layer of a semiconductor structure to expand the electrodes of the capacitor to amplify the capacitance of the capacitor.

It is another object of this invention to combine the processes for forming metal-metal capacitors and interconnection members. That is, the interconnection members can be formed while the metal-metal capacitors are fabricated over the uppermost layer of a semiconductor structure. Furthermore, in the method of this invention, the same mask is not only employed to pattern the dielectric layer of the metal-metal capacitor, but also utilized to etch the protective layer on the semiconductor structure to form a contact, wherein the contact can expose the bonding pad on the semiconductor structure. Accordingly, comparing with the process in the prior art, said process of this invention can save one mask.

In accordance with the above-mentioned objects, the invention provides a structure and fabricating method for metal-metal capacitor (MMC) over the uppermost layer of a semiconductor structure. The lower electrode of the metal-metal capacitor in this invention is located in the uppermost layer of a semiconductor structure. Moreover, the upper electrode of said metal-metal capacitor and a bonding pad could be formed in the same manufacturing, wherein the bonding pad is employed to connect the semiconductor structure and the outside. Therefore, it is efficiently for fabricating a metal-metal capacitor over the uppermost layer of a semiconductor structure by said method.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram showing a metal-metal capacitor in prior art;

FIG. 2 is an illustration of a metal-metal capacitor in this presented invention; and

FIG. 3 to FIG. 8 are a series of qualitative illustrations of this presented invention for steps of forming a metal-metal capacitor and an interconnection member.

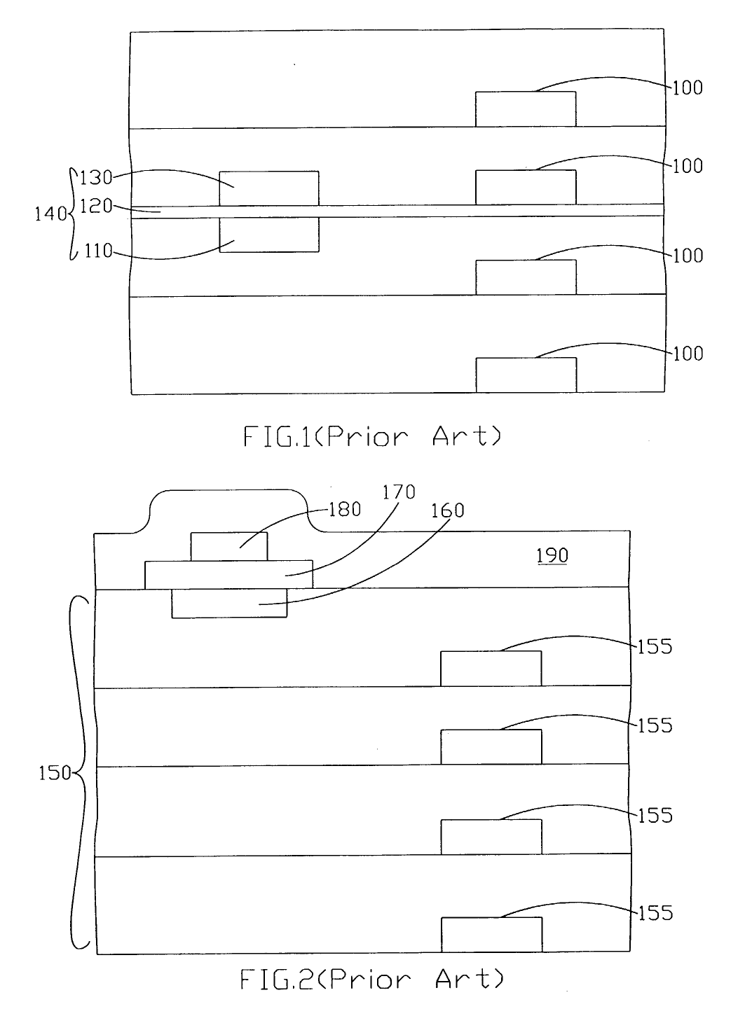

### DESCRIPTION OF THE PREFERRED EMBODIMENTS

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

Then, the components of the semiconductor devices are not shown to scale. Some dimensions are exaggerated to the related components to provide a more clear description and comprehension of the present invention.

As shown in FIG. 2, one preferred embodiment of this invention is a structure of a metal-metal capacitor over an uppermost blanket of a semiconductor structure. Referred to FIG. 2, there is a first metal layer 160 in the uppermost layer of a semiconductor structure 150, wherein the semiconductor structure 150 comprises plurality of interconnection members 155. The first metal layer 160 is a component of Cu, or the like. There is a dielectric layer 170 on the first metal layer 160, wherein the dielectric layer 170 may be made of silicon oxide, or silicon nitride. A secondary metal layer 180 is on the dielectric layer 170, wherein the secondary metal layer 180 is as a upper electrode of the metal-metal capacitor. The composition of the secondary metal layer 180 is Cu, Al, and so on. Said metal-metal capacitor is located on the uppermost layer of the semiconductor structure 150. Specifically, excluding the protective layer 190 on the semiconductor structure 150 and the secondary metal layer 180, there is no member or device on the metal-metal capacitor. However, a bonding pad, not shown in FIG. 2, is on the semiconductor structure 150, wherein the bonding pad is formed with the secondary metal layer 180.

The capacitance of the metal-metal capacitor can be increased with the expansion of the electrode of said metal-metal capacitor. In the above-mentioned embodiment, the metal-metal capacitor was formed over the semiconductor structure, and there is enough space for the capacitor to extend the electrode of the metal-metal capacitor. On the other hand, the metal-metal capacitor in the prior art is fabricated in the semiconductor structure, and the extension of the electrode of the capacitor limits the capacitance of said metal-metal capacitor.

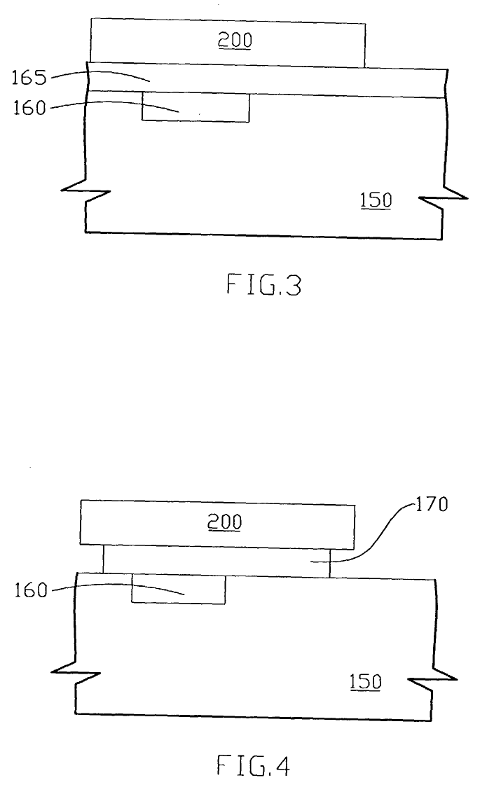

Referred to FIG. 3 to FIG. 8, another preferred embodiment of this invention is a method for manufacturing a metal-metal capacitor over an uppermost blanket of a semiconductor structure. Primarily, a first metal layer 160 is provided as the lower electrode of said metal-metal capacitor, wherein the first metal layer 160 is located in the uppermost layer of a semiconductor structure 150. The first metal layer 160 is made of Cu, and the first metal layer 160 may be formed by damascene. The semiconductor structure 150 comprises a plurality of members, such as interconnections, metal oxide semiconductors (MOS), etc. A covering dielectric layer 165 is deposited onto the semiconductor structure 150 and the first metal layer 160, as shown in FIG. 3. The covering dielectric layer 165 is preferably silicon nitride, or silicon oxide.

The next is an important step of this invention. In FIG. 3, a first mask 200 is employed to block on the covering dielectric layer 165, and then the covering dielectric layer 165 is “overetched”. That is, the etching process of the covering dielectric layer 165 is not only performed in the vertical direction of the surface of the semiconductor structure 150, but also in the parallel direction of the semiconductor 150. The etching procedure is performed, until the covering dielectric layer 165 after etching is absolutely covered by the first mask 200 and the area shadowed by the covering dielectric layer 165 is less than the area shadowed by the first mask 200. The covering dielectric layer 165 becomes a dielectric layer 170 on the first metal layer 160, as shown in FIG. 4.

After the covering dielectric layer 165 etched, a secondary metal layer 180 is deposited on the semiconductor structure 150 and the dielectric layer 170. A secondary mask 210 is utilized to pattern the secondary metal layer 180, as shown in FIG. 5. The secondary metal layer 180 is a component of Cu, Al, and so on.

Basically, according to the material of the secondary metal layer 180, the process for patterning the secondary metal layer 180 by the secondary mask 210 at least comprises following conditions. If the component of the secondary metal layer 180 is Al, said process comprises the steps of forming the secondary metal layer 180, masking and etching the secondary metal layer 180 with the secondary mask 210. If the secondary metal layer is made of Cu, said process comprises the steps of defining the desired position of the secondary metal layer 180, forming a Cu metal layer on the semiconductor structure 150, and removing the Cu metal layer excluding said desired position of the secondary metal layer 180 by chemical mechanical polishing (CMP) or the like wise.

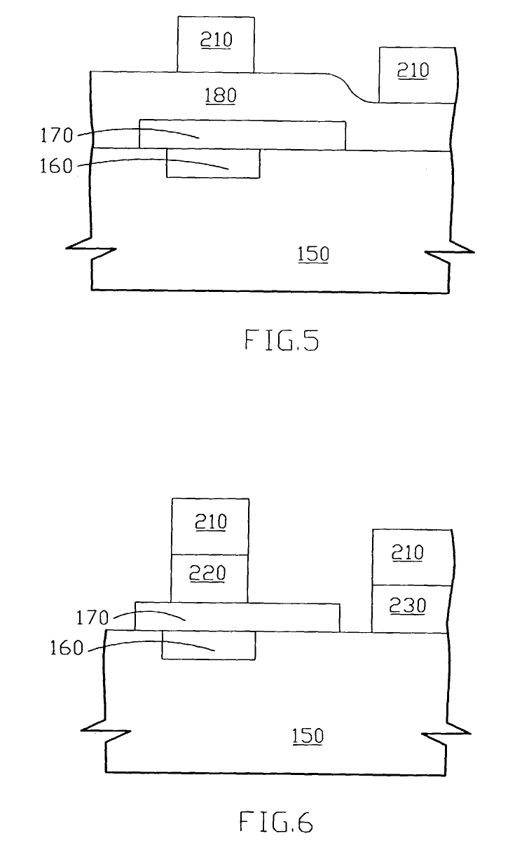

After patterning the desired position of the secondary metal layer 180 with the secondary mask 210, an upper electrode 220 will be formed on the dielectric layer 170, and a bonding pad 230 will be formed on the semiconductor structure 150, wherein the upper electrode 220 and the bonding pad 230 are separated from each other, as shown in FIG. 6.

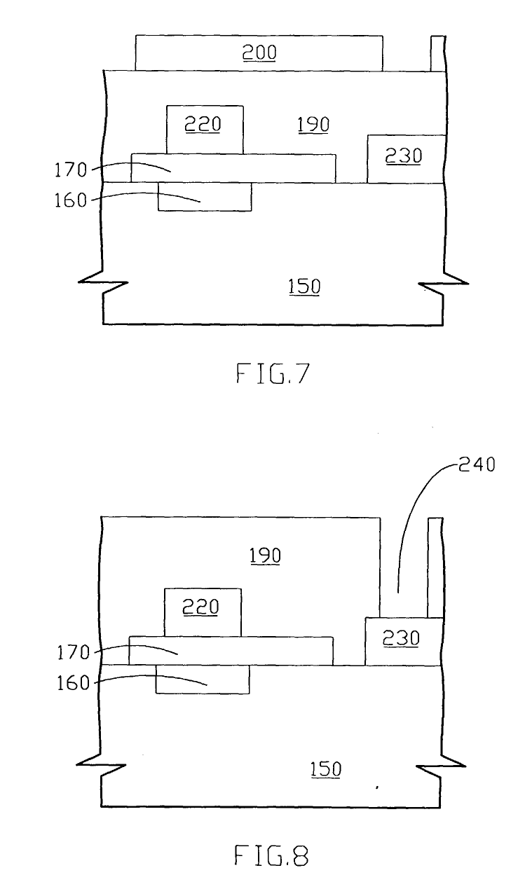

Referred to FIG. 7, after forming the metal-metal capacitor, a protective layer 190 is deposited on the semiconductor structure 150. The protective layer 190 may be made of phosphosilicate glass (PSG), silicon nitride, or a like wise material. In the next step, the first mask 200 is utilized again. Specifically, the first mask 200 is utilized to mask the protective layer 190, and then the protective layer 190 is etched. After the etching process, the protective layer 190 is still on the metal-metal capacitor, and an opening 240 is formed on the bonding pad 230 to expose the bonding pad 230. And then conductible materials will be filled into the opening 240 to form an interconnected line between the semiconductor structure 150 and the outside.

In said prior art, the metal-metal capacitor is fabricated in a semiconductor structure. If the metal-metal capacitor is taken to the position on a semiconductor structure, there are at least three masks required in the prior art process of fabricating a metal-metal capacitor. Wherein the first mask is for patterning the dielectric layer, the secondary mask is for patterning the upper electrode of said metal-metal capacitor, and the third mask is for patterning the protective layer on the semiconductor structure. However, in the above-mentioned embodiment, the process for producing a metal-metal capacitor over the semiconductor structure requires just two masks. The first mask is not only utilized to pattern the dielectric layer of the metal-metal capacitor, but also the protective layer on the semiconductor structure. The secondary mask is not only employed to pattern the upper electrode of the metal-metal capacitor, but also to fabricate the bonding pad on the semiconductor structure. Therefore, this invention can save one mask in the process for producing the metal-metal capacitor.

In the prior art, fabrication of a metal-metal capacitor and construction of a bonding pad of a semiconductor structure are two different processes. However, essentially, the upper electrode of a metal-metal capacitor and the bonding pad may be made of the same material. In said preferred embodiment of this invention, a desired bonding pad is constructed on the semiconductor structure while forming the upper electrode of the metal-metal capacitor on the dielectric layer. Thus, this invention can combine the fabricating processes of the metal-metal capacitor and the bonding pad.

According to the preferred embodiment, this invention discloses a method to form a metal-metal capacitor. This invention can extend the capacitance of the metal-metal capacitor and save one mask in the manufacture process by fabricating the capacitor over a semiconductor structure. Moreover, in this invention, an interconnection metal region can be formed with the manufacturing process of the metal-metal capacitor. Thus, the method of this present invention can increase the efficiency of the semiconductor manufacture.

Although specific embodiments have been illustrated and described, it will be obvious to those skilled in the art that various modifications may be made without departing from what is intended to be limited solely by the appended claims.

What is claimed is:

1. A structure of an integrated circuit with a metal-metal capacitor, wherein said structure comprising:
a first metal layer, wherein said first metal layer is in the uppermost layer of a semiconductor structure;
a dielectric layer, wherein said dielectric layer is on the first metal layer;
a secondary metal layer, wherein said secondary metal layer is on the dielectric layer;
a protective layer, wherein said protective layer is on the secondary metal layer and the semiconductor structure; and
a bonding pad, wherein said bonding pad crosses the protective layer.

2. The structure according to claim 1, wherein the semiconductor structure comprises a plurality of interconnection members.

3. The structure according to claim 1, wherein the first metal layer comprises Cu.

4. The structure according to claim 3, wherein the first metal layer is formed by damascene.

5. The structure according to claim 1, wherein the bonding pad is on the semiconductor structure, and the bonding pad and the secondary metal layer are separated.

6. A method for fabricating an integrated circuit with a metal-metal capacitor, wherein said method comprising:
forming a first metal layer, wherein the first metal layer is in a uppermost layer of a semiconductor structure;
forming a dielectric layer on the first metal layer;
forming a secondary metal layer on the dielectric layer;
forming a bonding pad on the semiconductor structure, wherein the bonding pad and the secondary metal layer are separated; and
forming a protective layer on the semiconductor structure and the secondary metal layer.

7. The method according to claim 6, wherein the semiconductor structure comprises a plurality of interconnection members.

8. The method according to claim 6, wherein the first metal layer comprises Cu.

9. The method according to claim 8, wherein the first metal layer is formed by damascene.

10. The method according to claim 6, wherein the step for forming the dielectric layer comprising:
forming a covering dielectric layer on the semiconductor structure and the first metal layer;
forming a first mask on the covering dielectric layer;
overetching the covering dielectric layer to form the dielectric layer, wherein the dielectric layer is completely masked by the first mask, and area of the dielectric layer is less than the first mask; and
removing the first mask.

11. The method according to claim 10, wherein the method comprises:
forming the first mask on the protective layer; and
etching the protective layer to expose the bonding pad.

12. The method according to claim 6, wherein the secondary metal layer and bonding pad are formed at the same time.

13. A method for fabricating an integrated circuit with a metal-metal capacitor, wherein said method comprising:
forming a first metal layer, wherein the first metal layer is in a uppermost layer of a semiconductor structure;
forming a dielectric layer onto the semiconductor structure and the first metal layer;
forming a first mask onto the dielectric layer;
overetching the dielectric layer, wherein the dielectric layer after etching is completely masked by the first mask, and area of the dielectric layer after etching is less than the first mask;
removing the first mask;
forming a secondary metal layer onto the semiconductor structure and the dielectric layer;
forming a secondary mask onto the secondary metal layer;
etching the secondary metal layer to form a bonding pad on the semiconductor structure and a upper electrode on the dielectric layer, wherein the bonding pad and the upper electrode are separated;
removing the secondary maskdepositing;
depositing a protective layer onto the semiconductor structure and the secondary metal layer;
forming the first mask onto the protective layer;
etching the protective layer to form a opening wherein the opening can expose the bonding pad; and
removing the first mask.

14. The method according to claim 13, wherein the semiconductor structure comprises a plurality of interconnection members.

15. The method according to claim 13, wherein the first metal layer comprises Cu.

16. The method according to claim 15, wherein the first metal layer is formed by damascene.
